(19) United States
(12) Patent Application Publication
(10) Pub. No.: US 2025/0158898 A1
(43) Pub. Date: May 15, 2025

(54) METHOD AND NETWORK NODE FOR GUIDED NETWORK SERVICE

(71) Applicant: Nokia Solutions and Nebworks Oy, Espoo (FI)

(72) Inventor: Edward GRINSHPUN, Murray Hill, NJ (US)

(21) Appl. No.: 18/838,476

(22) PCT Filed: Feb. 17, 2022
(86) PCT No.: PCT/US2022/016751

§ 371 Date: Aug. 14, 2024

(51) Int. Cl. H04L 41/5009; H04L 47/20; H04L 47/24

(52) U.S. Cl. CPC H04L 41/5009; H04L 47/20; H04L 47/24

(57) ABSTRACT

The method includes obtaining, by at least one processor of at least one first network node within a communication network, at least one first key performance metrics (KPM) data type, from a plurality of KPM data types, the plurality of KPM data types including current KPM data, predicted KPM data and predicted guaranteed KPM data, transmitting, by the at least one processor, at least one first parameter to an application function, the at least one first parameter identifying the at least one first KPM data type; and controlling, by the at least one processor, an operation of the application function based on the at least one first parameter.

### BACKGROUND

### Field

One or more example embodiments relate to wireless communications networks.

### Related Art

Wireless communication networks include user equipments that interface with application functions. Application function capabilities can impact a user experience for the user equipment.

### SUMMARY

At least one first example embodiment includes a method.

In at least one example embodiment, the method includes obtaining, by at least one processor of at least one first network node within a communication network, at least one first key performance metrics (KPM) data type, from a plurality of KPM data types, the plurality of KPM data types including current KPM data, predicted KPM data and predicted guaranteed KPM data; transmitting, by the at least one processor, at least one first parameter to an application function, the at least one first parameter identifying the at least one first KPM data type; and controlling, by the at least one processor, an operation of the application function based on the at least one first parameter.

In at least one example embodiment, the obtaining of the at least one first KPM data type includes first determining resource information, the resource information including an availability of prediction resources and guaranteed prediction enforcement resources, second determining policy information for a data flow at the application function, the policy information including policy capability information and guaranteed prediction enforcement capability information, third determining advertising information for the data flow based on the resource information and the policy information, the advertising information corresponding to the at least one first KPM data type.

In at least one example embodiment, the transmitting of the at least one first parameter further includes transmitting the advertising information to the application function, the advertising information including the at least one first parameter, the at least one first parameter identifying the KPM data type for one or more KPMs.

In at least one example embodiment, the method further includes receiving, from the application function, a selected KPM data type for a first KPM of the one or more KPMs, the selected KPM data type being one of the plurality of KPM data types

In at least one example embodiment, the selected KPM data type is one of a first KPM service associated with the current KPM data, a second KPM service associated with the predicted KPM data, or a third KPM service associated with the predicted guaranteed KPM data, the selected KPM data type identifying one of the first KPM service, the second KPM service or the third KPM service.

In at least one example embodiment, the method further includes processing at least one first data report for at least one first duration of time for the first KPM based on the selected KPM data type, wherein the controlling of the operation of the application function includes transmitting the selected KPM data type and at least one KPM value for the first KPM to the application function to cause the application function to adapt an application session to a network state.

In at least one example embodiment, the one or more KPMs includes at least one of throughput, latency, jitter, user equipment channel quality, packet loss, or allocated radio access network (RAN) resources.

In at least one example embodiment the processing processes the at least one first data report by performing at least one of the following processing the at least one first data report to produce at least one first current KPM value if the selected KPM data type identifies the first KPM service, or processing the at least one first data report to produce at least one first predicted KPM value, if the selected KPM data type identified the second KPM service or the third KPM service, or processing the at least one first data report to produce at least one first predicted guaranteed KPM value, if the selected KPM data type identified the third KPM service.

In at least one example embodiment, the controlling of the operation of the application includes transmitting the at least one first current KPM value to the application function if the selected KPM data type identified the first KPM service, transmitting the at least one first predicted KPM value to the application function if the selected KPM data type identified the second KPM service, or transmitting the at least one first predicted KPM value and the at least one first predicted guaranteed KPM value to the application function if the selected KPM data type identified the third KPM service, the at least one KPM value including the at least one first current KPM value, the at least one first predicted KPM value or the at least one first predicted guaranteed KPM value.

In at least one example embodiment, the selected KPM data type identifies the third KPM service, and the processing processes the at least one first data to produce at least one first predicted KPM value and at least one first predicted guaranteed KPM value, and the controlling of the operation of the application includes transmitting the at least one first predicted KPM value and the at least one first predicted guaranteed KPM value to the application function, the at least one KPM value including the at least one first predicted KPM value and the at least one first predicted guaranteed KPM value, the method further comprising: enforcing at least one enforcement parameter based on the at least one first predicted guaranteed KPM value.

In at least one example embodiment the at least one processor is part of at least one of: a near-real time (RT) radio access network intelligent controller (RIC), the near-RT RIC being within the at least one first network node, a non-real time radio access network intelligent controller (RIC), the non-RT RIC being within the at least one first network node, a network exposure function (NEF), the network exposure function being within the at least one first network node, a Service Management and Orchestration (SMO) function, the SMO function being within the at least one first network node, or a Mobile Edge Computing (MEC) platform.

At least one example embodiment includes at least one first network node within a communication network.

In at least one example embodiment, the at least one first network node includes a memory storing computer readable instructions; and at least one processor operationally connected to the memory to access the computer readable instructions in order to obtain at least one first key performance metrics (KPM) data type, from a plurality of KPM data types, the plurality of KPM data types including current KPM data, predicted KPM data and predicted guaranteed KPM data; transmit at least one first parameter to an application function, the at least one first parameter identifying the at least one first KPM data type; and control an operation of the application function based on the at least one first parameter.

In at least one example embodiment, the at least one processor is configured to obtain the at least one first KPM data type by first determining resource information, the resource information including an availability of prediction resources and guaranteed prediction enforcement resources, second determining policy information for a data flow at the application function, the policy information including policy capability information and guaranteed prediction enforcement capability information, third determining advertising information for the data flow based on the resource information and the policy information, the advertising information corresponding to the at least one first KPM data type.

In at least one example embodiment, the at least one processor is configured to transmit the at least one first parameter by transmitting the advertising information to the application function, the advertising information including the at least one first parameter, the at least one first parameter identifying the KPM data type for one or more KPMs.

In at least one example embodiment, the at least one processor is further configured to receive, from the application function, a selected KPM data type for a first KPM of the one or more KPMs, the selected KPM data type being one of the plurality of KPM data types.

In at least one example embodiment the selected KPM data type is one of a first KPM service associated with the current KPM data, a second KPM service associated with the predicted KPM data, or a third KPM service associated with the predicted guaranteed KPM data, the selected KPM data type identifying one of the first KPM service, the second KPM service or the third KPM service.

In at least one example embodiment, the at least one processor is further configured to process at least one first data report for at least one first duration of time for the first KPM based on the selected KPM data type, wherein the controlling of the operation of the application function includes transmitting the selected KPM data type and at least one KPM value for the first KPM to the application function to cause the application function to adapt an application session to a network state.

In at least one example embodiment, the one or more KPMs includes at least one of throughput, latency, jitter, user equipment channel quality, packet loss, or allocated radio access network (RAN) resources.

In at least one example embodiment the at least one processor processes the at least one first data report by performing at least one of the following processing the at least one first data report to produce at least one first current KPM value if the selected KPM data type identifies the first KPM service, or processing the at least one first data report to produce at least one first predicted KPM value, if the selected KPM data type identified the second KPM service or the third KPM service, or processing the at least one first data report to produce at least one first predicted guaranteed KPM value, if the selected KPM data type identified the third KPM service.

In at least one example embodiment the at least one processor is further configured to control the operation of the application by transmitting the at least one first current KPM value to the application function if the selected KPM data type identified the first KPM service, transmitting the at least one first predicted KPM value to the application function if the selected KPM data type identified the second KPM service, or transmitting the at least one first predicted KPM value and the at least one first predicted guaranteed KPM value to the application function if the selected KPM data type identified the third KPM service, the at least one KPM value including the at least one first current KPM value, the at least one first predicted KPM value or the at least one first predicted guaranteed KPM value.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 illustrates an open radio access network (O-RAN) hierarchy, in accordance with at least one example embodiment;

FIG. 2 illustrates a block diagram of a network node, in accordance with at least one example embodiment;

FIG. 3 illustrates a flowchart of logic for selecting advertisement information, in accordance with at least one example embodiment;

FIG. 4A illustrates a communication diagram for a service registration by an application function, in accordance with at least one example embodiment;

FIG. 4B illustrates a multi-access edge computing framework that includes an application function, in accordance with at least one example embodiment;

FIG. 5 illustrates a communication diagram for a guided network service operation in a radio access network intelligent controller (RIC), in accordance with at least one example embodiment;

FIG. 6 illustrates a method of guided network services, in accordance with at least one example embodiment;

FIG. 7 illustrates a functional diagram depicting a flow of information for Use Case 1, in accordance with at least one example embodiment;

FIG. 8 illustrates a functional diagram depicting a flow of information for Use Case 2, in accordance with at least one example embodiment;

FIG. 9 illustrates a functional diagram depicting a flow of information for Use Case 3, in accordance with at least one example embodiment.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

While one or more example embodiments may be described from the perspective of radio network elements (e.g., gNB, eNB), user equipment, or the like, it should be understood that one or more example embodiments discussed herein may be performed by the one or more processors (or processing circuitry) at the applicable device. For example, according to one or more example embodiments, at least one memory may include or store computer program code, and the at least one memory and the computer program code may be configured to, with at least one processor, cause a radio network element (or user equipment) to perform the operations discussed herein.

It will be appreciated that a number of example embodiments may be used in combination.

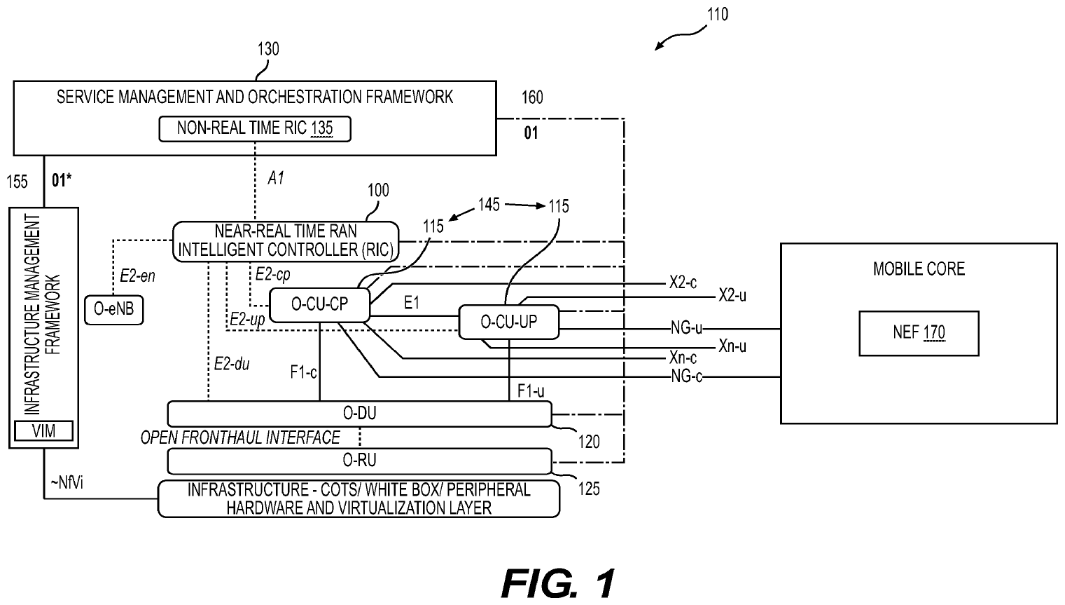

FIG. 1 illustrates a system 110 that includes an open radio access network (O-RAN) hierarchy, in accordance with at least one example embodiment. In at least one example embodiment, the system 110 includes radio side entities that include a radio side of the O-RAN system 110 includes a Near-real time radio access network intelligent controller (Near RT RIC) 100, at least one open RAN control plane (O-CU-CP) 115, an open RAN distributed unit (O-DU) 120, and an open RAN radio unit (O-RU) 125, as these radio side entities are defined by 3GPP TR 21.905. The management side includes management side entities that include a Service Management and Orchestration Framework (SMO) 130 that contains a Non-RT-RIC function 135, where these management side entities are defined by 3GPP TR 21.905.

In at least one example embodiment, other entities within the system 110 include some of all of the following:

An open radio access network (O-RAN) near-real-time RAN Intelligent Controller (near-RT RIC) 100: a logical function that enables near-real-time control and optimization of O-RAN elements and resources via fine-grained data collection and actions over E2 interface.

An O-RAN non-real-time RAN Intelligent Controller (non-RT RIC) 135: A logical function that enables non-real-time control and optimization of RAN elements and resources, AI/ML workflow including model training and updates, and policy-based guidance of applications/features in near-RT RIC 100.

O-CU 145: O-RAN Central Unit: a logical node hosting radio resources control (RRC), service delivery automation platform (SDAP) and packet data convergence protocols (PDCP).

O-CU-CP 115: O-RAN Central Unit-Control Plane 115: a logical node hosting the RRC and the control plane part of the PDCP protocol.

O-CU-UP 140: O-RAN Central Unit-User Plane: a logical node hosting the user plane part of the PDCP protocol and the SDAP protocol.

O-DU 120: O-RAN Distributed Unit: a logical node hosting RLC/MAC/High-PHY layers based on a lower layer functional split.

O-RU 125: O-RAN Radio Unit: a logical node hosting Low-physical (PHY) layer and radio frequency (RF) processing based on a lower layer functional split. This is similar to 3GPP's “TRP” or “RRH” but more specific in including the Low-PHY layer (FFT/iFFT, PRACH extraction).

O1 160: Interface between management entities in Service Management and Orchestration Framework and O-RAN managed elements, for operation and management, by which FCAPS management, Software management, File management shall be achieved.

O1* 155: Interface between Service Management and Orchestration Framework and Infrastructure Management Framework supporting O-RAN virtual network functions.

In at least one example embodiment, the O-RAN Near-RT RIC 100 enables providing near real time RAN key performance metrics (KPMs) (e.g throughput, latency, jitter, UE channel quality, allocated RAN resources, etc.) to 3rd party application services. In at least one example embodiment, examples of such 3rd party app services may include, but are not limited to, live streaming video, mobile robot control on a smart factory 4.0 floor, mobile gaming, augmented reality/virtual reality (AR/VR). In at least one example embodiment, knowing KPMs allows the application service to significantly improve Quality of Experience (QoE) via fast adaptation of application traffic needs to the network performance, for example adjusting video and data stream resolution, meta-data resolution and speed of autonomously guided vehicles and mobile robots, and amount of data streamed details, etc.

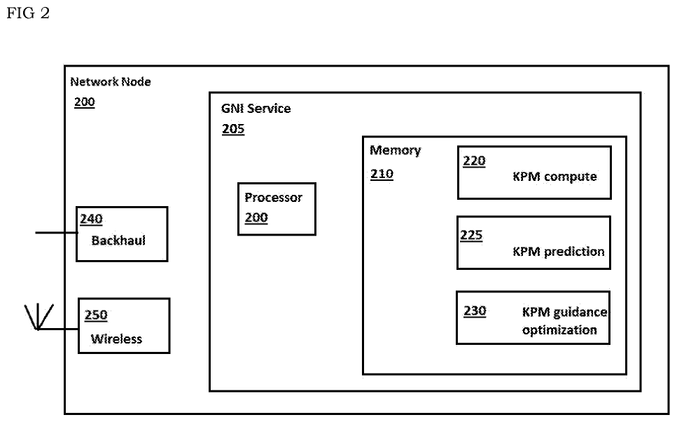

FIG. 2 illustrates a block diagram of a network node 200, in accordance with at least one example embodiment.

In at least one example embodiment, the network node 200 is the near RT RIC 100. In at least one example embodiment, the network node 200 is the non-real time RIC 135, the NEF function 170, the SMO function 130 or a MEC platform 450. In at least one example embodiment, the network node 200 includes a guided network service unit 205. In at least one example embodiment, the guided network service unit 205 includes a memory 210 operationally connected to a processor 200. In at least one example embodiment, the memory includes computer readable instructions that are readable by the processor 200 in order to control at least some of the operations of the network node 200. In at least one example embodiment, the memory 210 includes at least KPM computing instructions 220, a KPM prediction instructions 225 and KPM guidance optimization instructions 230. In at least one example embodiment, the network node 200 includes a backhaul 240 and/or a wireless interface 250 for interfacing with entities external to the network node 200.

In at least one example embodiment, an application function (AF) ultimately needs access to accurately predicted KPM data, so that prediction can be accomplished by the processor 200 of the network node 200, in order to properly adjust to predicted network conditions, as described herein. In at least one example embodiment, there are 3 use cases associated with 3 types of per UE KPM data information exposed to the AF by the network node 200.

Use case 1 (service type 1): The processor 200 of the network node 200 exposes preprocessed ‘raw’ (current) KPM data as computed from RAN DU and/or CU reports. The processor 200 of the network node 200 assumes trained predictor hosted by Application Service, with the data exposed by the network node 200 serving as an input to the predictor. There is no special treatment (or KPM enforcement) in the RAN DU/CU of a UE data flow carrying the application traffic

Use case 2 (service type 2): The network node 200 hosts the ML predictor function (including KPM prediction instructions 225) and exposes predicted KPM data to the AF, computed from RAN DU and/or CU reports. There is still no special treatment (or KPM enforcement) in the RAN DU/CU of the UE data flow carrying the application traffic. In at least one example embodiment, the AF does not have a predictor and the AF can be directly exposed to the predicted KPMs for adapting the predicted network state.

Use case 3 (service type 3): The network node 200 hosts ML predictor and in addition performs spectral resource allocation optimization. It processes reports from DU and/or CU are processed to compute ‘intermediate KPM’ (example—UE-channel characteristics, resource allocation, latency, jitter).

Predictor is applied to predict intermediate KPM. Optimizer is applied (optimizer input: predicted intermediate KPMs and resource allocation policy) to compute optimal resource allocation across many UEs and associated predicted guaranteed KPMs (example-throughput, latency, packet loss, resource allocation). The computed predicted guaranteed KPMs are exposed (transmitted) to the AF, and also enforced in the DU and/or CU.

The Application Service needs to distinguish between these 3 use cases (described above) to properly act on the information. The differences between the 3 use cases include the following factors:

Factor 1: Where is the trained predictor located: within the network node 200 or within Application Function (AF). In other words, is the received by AF KPM data already predicted (predictor in network node 200) or it is historic or current data that still needs to be sent to predictor to obtain predicted KPM data

Factor 2: What is the accuracy of the prediction or prediction error margin. This dictates how aggressively (or alternatively how conservatively) the AF needs to be in adapting to the predicted network performance. In use case 3 the accuracy of exposed predicted data is higher than in other 2 use cases due to predicted KPMs being enforced in the RAN. Therefore in use case 3 the AF can aggressively adapt to the predicted KPMs. In other 2 use cases the AF needs to be more conservative in its adaptation to predicted KPMs, allowing for relatively large margin of error due to natural fluctuations in network KPMs (e.g. unpredicted variations patterns in PRB allocation due to new UEs being added or traffic fluctuations for existing UEs, unpredicted variations in channel conditions due to UE mobility and various temporary channel impairments causing random packet losses or delays)

In at least one example embodiment, a new parameter is (or set of parameters are) used to indicate a type of KPM (which use case described above), which is used to identify that the Near-RT RIC 100 is to expose: ‘raw’ (current) KPM (use case 1), predicted KPM (use case 2), or predicted guided KPM (use case 3).

In at least one example embodiment, the parameter is included in a service advertisements (see embodiment below).

In at least one example embodiment, the parameter is present as a protocol data field sent with respective data (data flow), when different use cases may coexist for different KPM parameters (e.g. use case 1 for latency and use case 3 for throughout).

In at least one example embodiment, for specific KPMs, the network node 200 advertises the supported exposed KPM type based upon the network node 200 capabilities, and based on policy (policy information) for specific app type (e.g. whether for a given KPM, such as for throughput, the network node 200 has a trained KPM predictor that can be deployed, and whether the network node 200 supports KPM guidance computation and enforcement, and whether RIC policies allow the predictor and guidance to be deployed for the specific Application service).

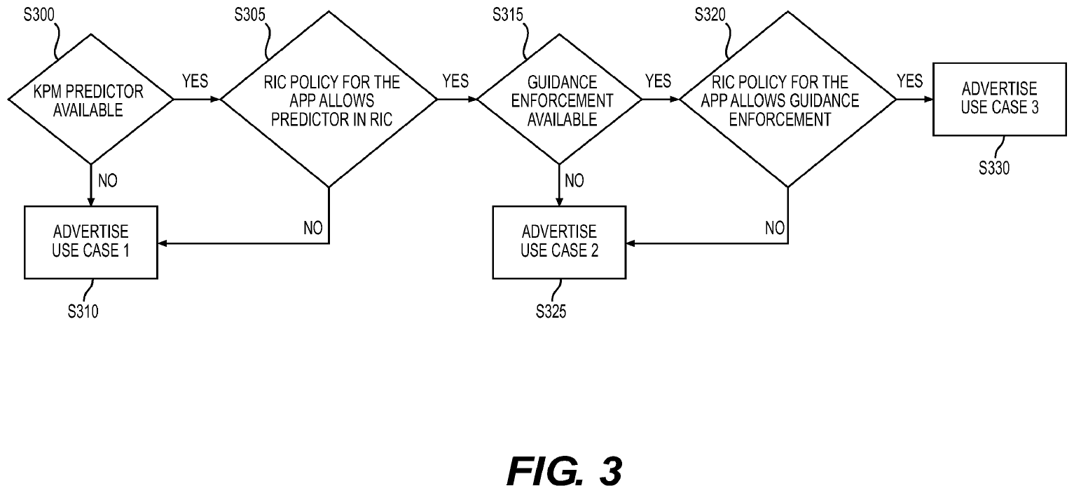

FIG. 3 illustrates a flowchart of logic for selecting advertisement information, in accordance with at least one example embodiment.

In at least one example embodiment, the processor 200 of the network node 200 performs the steps in FIG. 3. In at least one example embodiment, in step S300 the processor 200 determines if the network node 200 has the KPM predictor instructions (functionality) 225 available, and in step S305 the processor 200 determines if a RIC policy allows for the predictor to be used in the RIC. In the event either answer is “no”, then the processor 200 will advertise use case 1 (as explained herein in more detail). In at least one example embodiment, in step S315 the processor 200 determines if the network node 200 has the guidance optimization instructions 230, and in step S320 the network node 200 determines if the RIC policy allows for the guidance optimization to be used in the RIC (as explained in more detail herein). In the event either answer is “no”, the processor 200 will advertise use case 2. In the event steps S315 and S320 are answered in the affirmative, then in step S330 the processor will advertise use case 3.

In at least one example embodiment, different policies may apply for different application services, e.g. even though the network node 200 has capabilities to provide predicted guaranteed KPM (use case 3), for specific application the policy may allow to only expose ‘current’ KPM (use case 1) or only ‘predicted’ KPM (use case 2).

In at least one example embodiment, different use cases may be applied to different KPMs, for example the network node 200 may have Guidance enforcement capabilities (use case 3) for throughput KPM and provide ‘raw’ data (use case 1) for latency KPM.

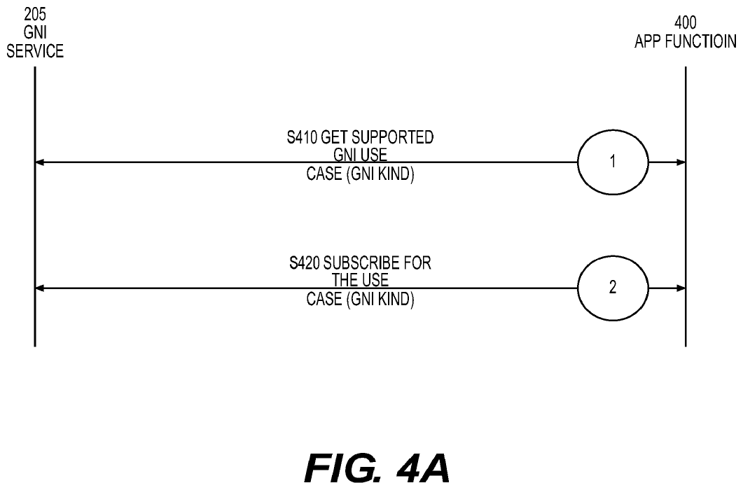

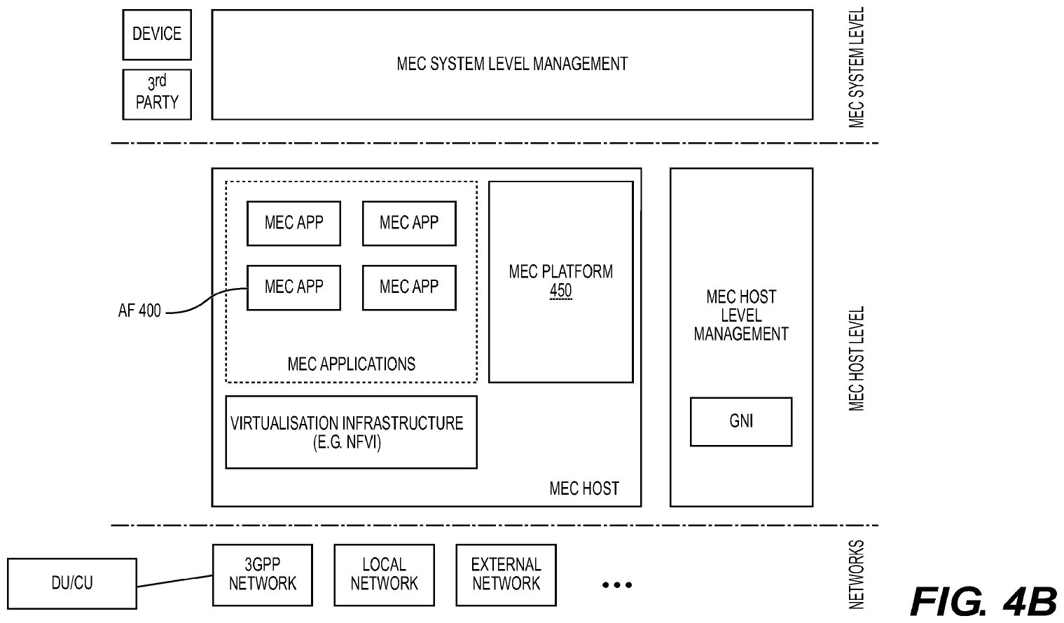

FIG. 4A illustrates a communication diagram for a service registration by an application function, in accordance with at least one example embodiment.

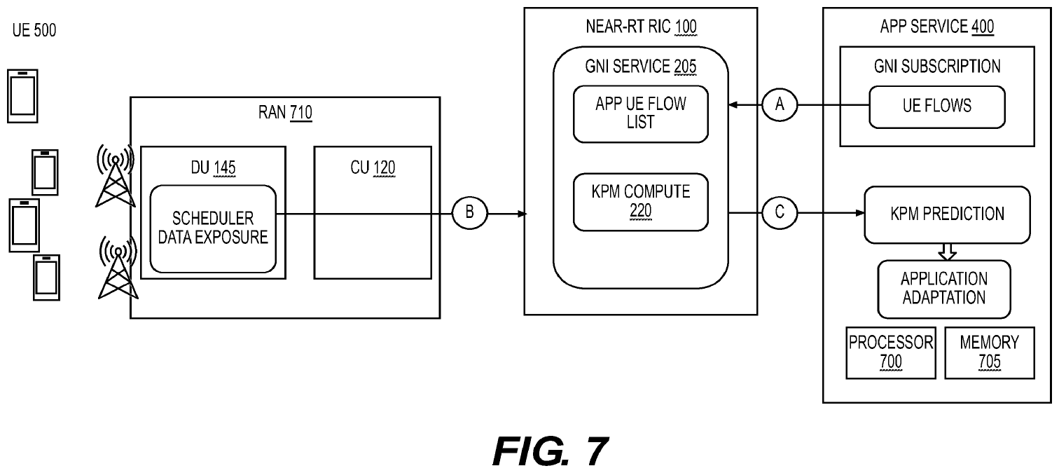

In at least one example embodiment, during a registration of an application function (AF) 400, a processor 700 (see FIG. 7) the AF 400 first receives an advertised GNI service use case from the GNI service 205, in step S410. GNI service stands for one of current, predicted or predicted guaranteed service.

In at least one example embodiment, the processor 700 of the AF 400 looks at its own capabilities (e.g. whether it can deploy its own predictor) and selects the service type to subscribe, in step S420. In at least one example embodiment, the GNI service 205 (as a part of the network node 200) optionally supports downgrading its advertised service (e.g. providing ‘raw insights’ (current KPM) use case 1 even if ‘predicted guided insights’ (predicted guaranteed KPM) use case 3 is available), if the AF 400 selects a lower tier service.

As a result of this negotiation by the AF 400 and GNI service 205, one of the use cases 1, 2, or 3 above is selected for service. In at least one example embodiment, the Near-RT RIC 100 then proceeds with the service according to the selected use case.

In at least one example embodiment, a combination of predictive capabilities of both the network node 200 and AF 400 are used together. This allows at least some of the example embodiments to allow for:

First: Using a combination of predictors in the network node 200 for some of the KPMs and in the AF 400 for other KPMs

Second: Allowing much more efficient spectral resource utilization when Guaranteed predictions (use case 3) are utilized with application function confidently adapting to the Predicted guaranteed KPMs.

FIG. 4B illustrates a multi-access edge computing framework that includes at least one application function 400, in accordance with at least one example embodiment.

In at least one example embodiment, the multi-access edge computing (MEC) platform 450 interfaces with MEC applications, where one of the MEC applications may be the AF 400.

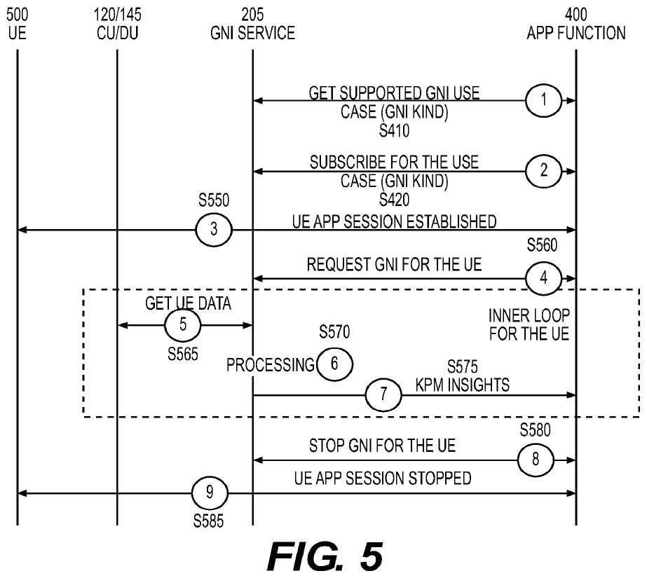

FIG. 5 illustrates a communication diagram for a guided network service operation in the network node 200, in accordance with at least one example embodiment.

In at least one example embodiment, a user equipment (UE) 500, the AF 400 and the CU 120/DU 145 have the same main structural elements (processor 200, memory 210, wireless interface 250 and/or backhaul 240) as shown in the network node 200 of FIG. 2, where a processor 200 runs the operations of these entities based on computer readable instructions in the memory 210.

Step 1 (S410). AF 400 finds out which use case for the given KPM k is supported by network node 200. This step is omitted in the functional diagrams of FIGS. 7, 8 and 9.

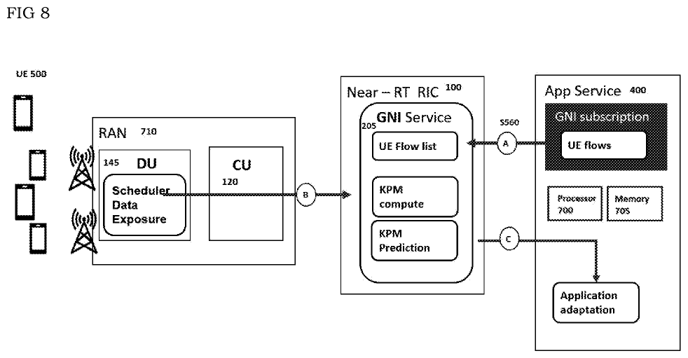

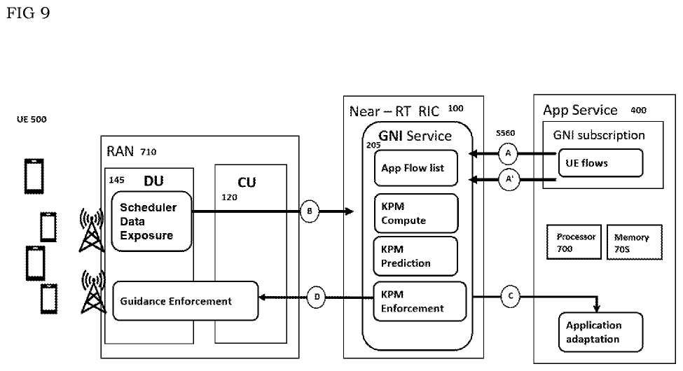

Step 2 (S420). AF 400 subscribes for the selected use case. If use case 1 is selected for KPM k, then AF 400 deploys a trained predictor (FIG. 7). If use case 2 is selected, the network node 200 deploys a trained predictor for the KPM k (FIG. 8). If use case 3 is selected, the network node 200 deploys trained predictor for the KPM k and deploys Guidance function for RAN control (FIG. 9). This step is omitted in the functional diagrams of FIGS. 7, 8 and 9.

Step 3 (S550)—Application session is established between AF and a user equipment (UE) 500. This step is omitted in the functional diagrams of FIGS. 7, 8 and 9.

Step 4 (S560)—AF 400 requests KPM reports from GNI service 205 in the RIC 50 for the UE 500, which starts the inner loop operation (step 1 in FIG. 7-9

Step 5 (S565)—GNI 205 receives “data reports,” which may be periodic or may be on demand, for the UE 500 from RAN DU 120 and/or CU 145 (step 2 in FIG. 7-9).

Step 6 (S570)—depends upon the use case.

Use Case 1 (service type 1): In use case 1, GNI 205 preprocess received data.

Use Case 2 (service type 2): In use case 2 GNI 250 preprocess the data and feeds it into the predictor to produce predicted KPM.

Use Case 3 (service type 3): In use case 3, in addition to operations in use case 2, GNI 205 runs Guidance function to compute predicted guaranteed KPMs and produce control parameters for the RAN to enforce the KPM.

Step 7 (S575)—reported KPM values sent to AF 400, with indication of the use case selected. AF 400 uses the reported KMP values based upon the use case: In case of use case 1 received KPM values are used as input to the predictor. Output of the predictor is used to conservatively adjust application behavior, with relatively larger error margin taken into account. In case of use case 2, received KPM values are used to conservatively adjust application behavior, with relatively larger error margin taken into account. In case of use case 3, received KPM values are used to aggressively adjust application behavior knowing that the predicted network performance is enforced and error margin is small.

Step 8 (S580): The GNI 205 ceases the connection with the AP 400.

Step 9 (S585): The UE 500 application session with the AF 400 ends.

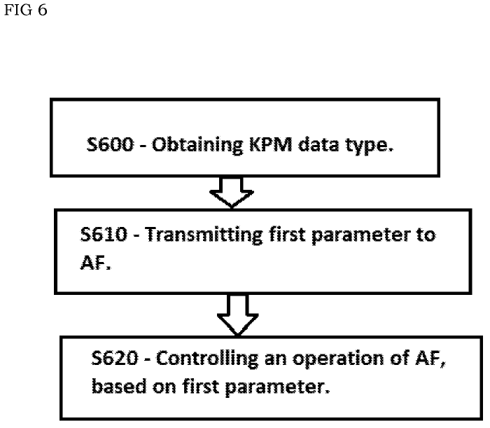

FIG. 6 illustrates a method of guided network services, in accordance with at least one example embodiment.

In at least one example embodiment, and as shown in step S600, the processor 200 of the network node 200 obtains a KPM data type. In at least one example embodiment, the KPM data type includes a first KPM service (Use Case 1) associated with a current KPM data, a second KPM service (use case 2) associated with a predicted KPM data or a third KPM service (use case 3) associated with a predicted guaranteed KPM data. In at least one example embodiment, the obtaining of the KPM data type includes determining resource information (availability of prediction resources or guaranteed prediction enforcement resources ( ) determining policy information (capability of guaranteed prediction enforcement capabilities) and determining advertising information (corresponding to the KPM data type), as described in at least FIG. 3.

In at least one example embodiment, in step S610 the processor 200 of the network node 200 transmits a parameter to the AF 400 (as described herein). In at least one example embodiment, the parameter is transmitted to the AF 400 in step 1 of FIG. 1, and the AF 400 stores the parameter and later associates the parameter with the KPM that is transmitted in step 7 of FIG. 5. In at least another example embodiment, the parameter is transmitted in step 7 of FIG. 5 along with the KPM values. In at least an example embodiment, combinations of these embodiments can be used to transmit the parameter.

In at least one example embodiment, in step S620 the processor 200 controls an operation of the AF 400 (as described herein). In at least one example embodiment, the controlling of an operation of the AF 400 can include transmitting a selected KPM data type and at least one KPM value for a particular KPM to the AF 400 to cause the AF 400 to adapt an application session to a network state.

FIG. 7 illustrates a functional diagram depicting a flow of information for Use Case 1, in accordance with at least one example embodiment. FIG. 8 illustrates a functional diagram depicting a flow of information for Use Case 2, in accordance with at least one example embodiment. FIG. 9 illustrates a functional diagram depicting a flow of information for Use Case 3, in accordance with at least one example embodiment.

In at least one example embodiment, the UE 500 has the same main structural elements (processor 200, memory 210, wireless interface 250) as the network node 200 of FIG. 2. While the near-RT RIC 100 is shown in FIGS. 7-9, it should be understood that the GNI 205 can be located in any of the entities that may be the network node 200, aside from the near-RT RIC 100.

In at least one example embodiment, and as shown in FIG. 7, an example of a Use Case 1 operation is shown, where step A is step S560 of FIG. 5.

In at least one example embodiment, and as shown in FIG. 8, an example of a Use Case 2 operation is shown, where steps 1 through 3 are described in relation to FIG. 5.

In at least one example embodiment, and as shown in FIG. 9, an example of a Use Case 3 operation (guided prediction of throughput KPM for gaming or live video streaming, as an example) is shown, where steps 1 through 4 are described in relation to FIG. 5, and also discussed below.

Step A: This step corresponds to step 4 of FIG. 3 of FIG. 5. In at least one example embodiment, in Step A′ the AF 400 sends a list of acceptable throughputs corresponding to different possible video encoding resolutions used in the UE 500 application session.

Step B: In Step B the GNI service 205 received periodic (e.g. every T secs, T is between 100 msec and 1 sec) reports (“data reports”) from DU 145 scheduler for all UEs 500 for which Application Service 400 is registered. The reports include data on physical resource blocks (PRB) allocation and UE 500 channel conditions. KPM compute module computes PRB resource allocation and UE 500 channel metrics. KPM prediction module predicts channel conditions for the UEs 500. Guidance optimization module takes the predicted channel conditions as input and solves the optimization problem to optimally set target throughput rates for all UEs 500 running the subscribed application to maximize given policy objective. Policy objective may be to maximize number of UEs 500 with at least video resolution r_max, while minimal acceptable video resolution is r_min (r_min and r_max being mapped to the throughputs provided in step 1′).

Step C: In Step C Guidance optimization sends to the DU 145 scheduler request to enforce the computed optimal throughputs.

Step D: In Step D the computed and enforced target rates (that take into account predicted channel conditions) are reported to AF 400. AF 400 proceeds to adjust video encoding precisely to the reported KPM, knowing that error margin is small due to reported predicted guided KPMs being enforced in a radio access network (RAN) 710.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing user equipment, base stations, an as Evolved Node B (eNBs), a remote radio head (RRH), a 5G base station (gNBs), femto base stations, network controllers, computers, or the like. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUS), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network element or network device to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, user equipment, base stations, eNBs, RRHs, gNBs, femto base stations, network controllers, computers, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUs, one or more microprocessors, one or more ASICs, or any other device or devices capable of responding to and executing instructions in a defined manner.

Benefits, other advantages, and solutions to problems have been described above with regard to specific embodiments of the present disclosure. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

1-20. (canceled)

21. A method, comprising:
obtaining, by at least one processor of at least one first network node within a communication network, at least one first key performance metrics (KPM) data type, from a plurality of KPM data types, the plurality of KPM data types including current KPM data, predicted KPM data and predicted guaranteed KPM data;
transmitting, by the at least one processor, at least one first parameter to an application function, the at least one first parameter identifying the at least one first KPM data type; and
controlling, by the at least one processor, an operation of the application function based on the at least one first parameter.

22. The method of claim 21, wherein the obtaining of the at least one first KPM data type includes
first determining resource information, the resource information including an availability of prediction resources and guaranteed prediction enforcement resources,
second determining policy information for a data flow at the application function, the policy information including policy capability information and guaranteed prediction enforcement capability information,
third determining advertising information for the data flow based on the resource information and the policy information, the advertising information corresponding to the at least one first KPM data type.

23. The method of claim 22, wherein the transmitting of the at least one first parameter further includes transmitting the advertising information to the application function, the advertising information including the at least one first parameter, the at least one first parameter identifying the KPM data type for one or more KPMs.

24. The method of claim 23, further comprising:
receiving, from the application function, a selected KPM data type for a first KPM of the one or more KPMs, the selected KPM data type being one of the plurality of KPM data types.

25. The method of claim 24, wherein the selected KPM data type is one of
a first KPM service associated with the current KPM data,
a second KPM service associated with the predicted KPM data, or
a third KPM service associated with the predicted guaranteed KPM data, the selected KPM data type identifying one of the first KPM service, the second KPM service or the third KPM service.

26. The method of claim 25, further comprising:
processing at least one first data report for at least one first duration of time for the first KPM based on the selected KPM data type,
wherein the controlling of the operation of the application function includes
transmitting the selected KPM data type and at least one KPM value for the first KPM to the application function to cause the application function to adapt an application session to a network state.

27. The method of claim 24, wherein the one or more KPMs includes at least one of throughput, latency, jitter, user equipment channel quality, packet loss, or allocated radio access network (RAN) resources.

28. The method of claim 26, wherein the processing processes the at least one first data report by performing at least one of the following
processing the at least one first data report to produce at least one first current KPM value if the selected KPM data type identifies the first KPM service, or
processing the at least one first data report to produce at least one first predicted KPM value, if the selected KPM data type identified the second KPM service or the third KPM service, or
processing the at least one first data report to produce at least one first predicted guaranteed KPM value, if the selected KPM data type identified the third KPM service.

29. The method of claim 28, wherein the controlling of the operation of the application includes
transmitting the at least one first current KPM value to the application function if the selected KPM data type identified the first KPM service,
transmitting the at least one first predicted KPM value to the application function if the selected KPM data type identified the second KPM service, or
transmitting the at least one first predicted KPM value and the at least one first predicted guaranteed KPM value to the application function if the selected KPM data type identified the third KPM service,
the at least one KPM value including the at least one first current KPM value, the at least one first predicted KPM value or the at least one first predicted guaranteed KPM value.

30. The method of claim 26, wherein the selected KPM data type identifies the third KPM service, and
the processing processes the at least one first data to produce at least one first predicted KPM value and at least one first predicted guaranteed KPM value, and
the controlling of the operation of the application includes transmitting the at least one first predicted KPM value and the at least one first predicted guaranteed KPM value to the application function, the at least one KPM value including the at least one first predicted KPM value and the at least one first predicted guaranteed KPM value,
the method further comprising:
enforcing at least one enforcement parameter based on the at least one first predicted guaranteed KPM value.

31. The method of claim 21, wherein the at least one processor is part of at least one of:
a near-real time (RT) radio access network intelligent controller (RIC), the near-RT RIC being within the at least one first network node,
a non-real time radio access network intelligent controller (RIC), the non-RT RIC being within the at least one first network node,
a network exposure function (NEF), the network exposure function being within the at least one first network node,
a Service Management and Orchestration (SMO) function, the SMO function being within the at least one first network node, or
a Mobile Edge Computing (MEC) platform.

32. At least one first network node within a communication network, comprising:
a memory storing computer readable instructions; and
at least one processor operationally connected to the memory to access the computer readable instructions in order to
obtain at least one first key performance metrics (KPM) data type, from a plurality of KPM data types, the plurality of KPM data types including current KPM data, predicted KPM data and predicted guaranteed KPM data;
transmit at least one first parameter to an application function, the at least one first parameter identifying the at least one first KPM data type; and
control an operation of the application function based on the at least one first parameter.

33. The at least one first network node of claim 32, wherein the at least one processor is configured to obtain the at least one first KPM data type by
first determining resource information, the resource information including an availability of prediction resources and guaranteed prediction enforcement resources,
second determining policy information for a data flow at the application function, the policy information including policy capability information and guaranteed prediction enforcement capability information,
third determining advertising information for the data flow based on the resource information and the policy information, the advertising information corresponding to the at least one first KPM data type.

34. The at least one first network node of claim 33, wherein the at least one processor is configured to transmit the at least one first parameter by transmitting the advertising information to the application function, the advertising information including the at least one first parameter, the at least one first parameter identifying the KPM data type for one or more KPMs.

35. The at least one first network node of claim 34, wherein the at least one processor is further configured to
receive, from the application function, a selected KPM data type for a first KPM of the one or more KPMs, the selected KPM data type being one of the plurality of KPM data types.

36. The at least one first network node of claim 35, wherein the selected KPM data type is one of
a first KPM service associated with the current KPM data,
a second KPM service associated with the predicted KPM data, or
a third KPM service associated with the predicted guaranteed KPM data, the selected KPM data type identifying one of the first KPM service, the second KPM service or the third KPM service.

37. The at least one first network node of claim 36, wherein the at least one processor is further configured to
process at least one first data report for at least one first duration of time for the first KPM based on the selected KPM data type,
wherein the controlling of the operation of the application function includes
transmitting the selected KPM data type and at least one KPM value for the first KPM to the application function to cause the application function to adapt an application session to a network state.

38. The at least one first network node of claim 35, wherein the one or more KPMs includes at least one of throughput, latency, jitter, user equipment channel quality, packet loss, or allocated radio access network (RAN) resources.

39. The at least one first network node of claim 37, where the at least one processor processes the at least one first data report by performing at least one of the following
processing the at least one first data report to produce at least one first current KPM value if the selected KPM data type identifies the first KPM service, or
processing the at least one first data report to produce at least one first predicted KPM value, if the selected KPM data type identified the second KPM service or the third KPM service, or
processing the at least one first data report to produce at least one first predicted guaranteed KPM value, if the selected KPM data type identified the third KPM service.

40. The at least one first network node of claim 39, wherein the at least one processor is further configured to control the operation of the application by
transmitting the at least one first current KPM value to the application function if the selected KPM data type identified the first KPM service,
transmitting the at least one first predicted KPM value to the application function if the selected KPM data type identified the second KPM service, or
transmitting the at least one first predicted KPM value and the at least one first predicted guaranteed KPM value to the application function if the selected KPM data type identified the third KPM service,
the at least one KPM value including the at least one first current KPM value, the at least one first predicted KPM value or the at least one first predicted guaranteed KPM value.
